(19) United States
(12) Patent Application Publication
(10) Pub. No.: US 2014/0222712 A1
(43) Pub. Date: Aug. 7, 2014

(54) DATA ACQUISITION, NORMALIZATION, AND EXCHANGE IN A RETAIL ECOSYSTEM

(71) Applicant: SPS COMMERCE, INC., MINNEAPOLIS, MN (US)

(72) Inventors: Luke Samaha, Minneapolis, MN (US); La Moine Zielieke, Knapp, WI (US); Scott Bjerstedt, Brooklyn Park, MN (US); Scott Bolduc, Prior Lake, MN (US)

(73) Assignee: SPS COMMERCE, INC., MINNEAPOLIS, MN (US)

(21) Appl. No.: 14/169,347

(22) Filed: Jan. 31, 2014

Related U.S. Application Data
(60) Provisional application No. 61/759,924, filed on Feb. 1, 2013.

(51) Int. Cl. G06Q 10/00

(52) U.S. Cl. CPC G06Q 10/00
USPC 705/342

(57) ABSTRACT

A method for normalizing and exchanging document data between trading partners in a retail ecosystem. The method may include acquiring electronic documents from a plurality of sending trading partners, each electronic document from the sending trading partners provided in a format corresponding to which trading partner the electronic document came from, and each electronic document having a document type. The method may transform the electronic documents to a normalized format based on map objects, each relating to a corresponding document type, the map objects generated based on specification models defined by the trading partners, the specification models defining relationships between data specifications of the trading partners for the document types and data specifications for the normalized format for the document types. Each transformed electronic document may de-normalized from the normalized format to one or more output formats based on the map objects for the corresponding document type.

### CROSS-REFERENCE TO RELATED APPLICATIONS

The present application claims the benefit of U.S. Prov. Pat. Appl. No. 61/759,924, titled “Method and System for a Retail Ecosystem Allowing Rapid Integration, Categorization and Analysis of Participants,” filed Feb. 1, 2013, the contents of which are hereby incorporated by reference herein in their entirety.

### FIELD OF THE INVENTION

The present disclosure relates to retail ecosystems and supply chain management. Particularly, the present disclosure relates to systems and methods for data acquisition, normalization, and exchange in a retail ecosystem.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The supply chain management industry serves thousands of retailers around the world, speeding the ordering, fulfillment, and disposition of goods and services from tens of thousands of suppliers. Additional participants in this market include distributors, third-party logistics providers, manufacturers, fulfillment and warehousing providers, factoring firms, and sourcing companies. This network of participants can be defined as a retail ecosystem comprised of a network of organizations, including suppliers, distributors, customers, competitors, government agencies, and others involved in the delivery of a specific product or service through both competition and cooperation. The idea is that each business in the “ecosystem” affects, and is affected by, the others, creating a constantly evolving relationship in which each business must be flexible and adaptable in order to survive, as in a biological ecosystem.

Supply chain management solutions in a retail ecosystem must address trading partners' needs for integration, collaboration, connectivity, visibility, and data analytics to improve the speed, accuracy, and efficiency with which goods are ordered and supplied. A significant hurdle in addressing such concerns is the sheer number of connections that exist between retailers, suppliers, and other trading participants of the retail ecosystem. In view of the foregoing, conventional communications standards have not generally permitted efficient connection between these retailers, suppliers, or other trading participants. Despite the use of data formats with standardized syntax, the exchange of data or information under conventional methods has been performed in the context of a specific, one-to-one, sender/receiver relationship within a retail ecosystem, with the sender and receiver each carefully parsing through the communications received from the other in order to access the necessary or desired data.

Accordingly, further improvements in normalization methods for more efficient automation of the exchange of data between various trading partners is needed. Specifically, there is a need to develop systems and methods to reduce or eliminate the inefficiencies of current supply chain management data intake and to develop systems and methods for rapidly integrating and managing such intake data. More specifically, there is a need for improved systems and methods for data acquisition, normalization, and exchange in a retail ecosystem. Still further, there is a need for more efficient systems and methods for managing the connections that exist between trading partners of the retail ecosystem, as well as the integration, customization, and servicing of each new trading partner connection.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for normalizing and exchanging document data relating to an exchange of goods between trading partners in a retail ecosystem. The method may include acquiring electronic document data from a first trading partner through an electronic network, the electronic document data provided in a first format and relating to a document type utilized by the first trading partner in exchanging goods between one or more other trading partners in the retail ecosystem. The method may also include transforming the electronic document data to a normalized format based on a dynamic map object for the document type generated based on a first specification model defined by the first trading partner. The first specification model may define relationships between data specifications of the first trading partner for the document type and data specifications for the normalized format for the document type. The transformed electronic document data may be stored in the normalized format in a normalized data storage repository comprised of one or more computer readable storage devices. The method may further include de-normalizing the transformed electronic document data from the normalized format to a second format based on a dynamic map object for the document type generated based on a second specification model defined by a second trading partner. Similar to the first specification model, the second specification model may define relationships between data specifications of the second trading partner for the document type and data specifications for the normalized format for the document type. The de-normalized electronic document data may then be transmitted in the second format to the second trading partner through the electronic network.

In some embodiments, acquiring electronic document data from a first trading partner through an electronic network may include acquiring the electronic document data through a universal adapter module, permitting polling of one or more of the first trading partner's systems for new document data and pulling the new document data therefrom. In some embodiments, the method may further include storing the electronic document data provided in a first format in a storage repository comprised of one or more computer readable storage devices. In further embodiments, the transformation of the electronic document data to a normalized format may generally be independent of where the electronic document data is destined. In additional embodiments, the first specification model defined by the first trading partner may also define one or more data constraints for data within the electronic document data. Accordingly, transforming the electronic document data to a normalized format may include validating data within the electronic document data based on the one or more data constraints defined by the first trading partner. In further embodiments, the method may include dynamic routing of normalized data to two or more trading partners. For example, in some embodiments, the method may further include de-normalizing the transformed electronic document data from the normalized format to a third format based on a dynamic map object for the document type generated based on a third specification model defined by a third trading partner, the third specification model defining relationships between data specifications of the third trading partner for the document type and data specifications for the normalized format for the document type. The de-normalized electronic document data may then be sent in the third format to the third trading partner through the electronic network. In some embodiments, a document rules engine may modify the electronic document data based on specifications defined by the second trading party relating to at least one of an identification of the first trading party and an identification of a relationship between the first and second trading partners. In additional embodiments, de-normalizing the transformed electronic document data from the normalized format may include modifying the electronic document data based on data cross-referenced from data sources other than the electronic document data. Similarly, in some embodiments, the method may include correlating the electronic document data acquired from the first trading partner with other document data acquired by another trading partner based on data within the electronic document data from the first trading partner, so as to correlate related documents.

The present disclosure, in another embodiment, relates to a system for normalizing and exchanging document data relating to an exchange of goods between trading partners in a retail ecosystem. The system may include a data intake module, operably connected with an electronic network, acquiring electronic document data from a first trading partner through the electronic network, the electronic document data provided in a first format and relating to a document type utilized by the first trading partner in exchanging goods between one or more other trading partners in the retail ecosystem. The system may also include one or more transformation engines receiving the electronic document data from the intake module and transforming the electronic document data to a normalized format based on a dynamic map object for the document type generated based on a first specification model defined by the first trading partner. The one or more transformation engines may also de-normalize the transformed electronic document data from the normalized format to a second format based on a dynamic map object for the document type generated based on a second specification model defined by a second trading partner. The first specification model may define relationships between data specifications of the first trading partner for the document type and data specifications for the normalized format for the document type. Likewise, the second specification model may define relationships between data specifications of the second trading partner for the document type and data specifications for the normalized format for the document type. The system may include a normalized data storage repository, comprised of one or more computer readable storage devices, storing the transformed electronic document data in the normalized format. The system may also include a data export module, operably connected with the electronic network, transmitting the de-normalized electronic document data in the second format to the second trading partner through the electronic network.

In one embodiment, the system may further include an Internet-based user interface, accessible over an electronic network, through which each trading partner of the retail ecosystem may define one or more specification models for one or more corresponding document types. In further embodiments, the Internet-based user interface may be a graphical user interface through which each trading partner of the retail ecosystem may define its one or more specification models using graphical interface widgets, without requiring an underlying understanding of computer programming code. In still further embodiments, the Internet-based user interface may include a trading partner accessible programming code editing pane, permitting a trading partner to utilize computer programming code to define at least a portion of its one or more specification models.

In some embodiments, the system may further include a transformation library, comprised of one or more computer readable storage devices, storing the dynamic map objects. In some embodiments, the system may further include a document rules engine modifying the electronic document data based on specifications defined by the second trading party relating to at least one of an identification of the first trading party and an identification of a relationship between the first and second trading partners. In still further embodiments, the system may have the ability to dynamically route normalized data to two or more trading partners. In this regard, the one or more transformation engines further de-normalize the transformed electronic document data from the normalized format to a third format based on a dynamic map object for the document type generated based on a third specification model defined by a third trading partner, wherein the third specification model defines relationships between data specifications of the third trading partner for the document type and data specifications for the normalized format for the document type. The data export module may thus further transmit the de-normalized electronic document data in the third format to the third trading partner through the electronic network.

The present disclosure, in yet another embodiment, relates to a method for normalizing and exchanging document data relating to an exchange of goods between trading partners in a retail ecosystem. The method may include acquiring electronic documents from a plurality of sending trading partners through an electronic network, each electronic document from the sending trading partners provided in a format corresponding to which trading partner the electronic document came from, and each electronic document having a document type. The method may transform the electronic documents to a normalized format based on dynamic map objects, each relating to a corresponding document type, the map objects generated based on specification models defined by the trading partners, the specification models defining relationships between data specifications of the trading partners for the document types and data specifications for the normalized format for the document types. The method may further store the transformed electronic documents in the normalized format in a normalized data storage repository comprised of one or more computer readable storage devices. Further yet, the method may de-normalize each transformed electronic document from the normalized format to one or more output formats based on the dynamic map objects for the corresponding document type and transmit the de-normalized electronic documents in the one or more output formats to receiving trading partners through the electronic network. In some embodiments, transformations occurring during the transforming of electronic documents to a normalized format may be isolated from the transformations occurring during the de-normalizing of transformed electronic documents from the normalized format.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic illustration of a data acquisition, normalization and exchange method and system in accordance with one embodiment of the present disclosure.

FIG. 2 is a schematic illustration of a data acquisition, normalization and exchange method and system in accordance with another embodiment of the present disclosure.

FIG. 3 is an illustration of an example user interface for creating specification models to generate data map objects for the transformation library.

FIG. 4 is a schematic illustration of a data acquisition, normalization and exchange method and system in accordance with an embodiment of the present disclosure.

### DETAILED DESCRIPTION

The present disclosure relates to retail ecosystems and supply chain management. Particularly, the present disclosure relates to novel and advantageous systems and methods for data acquisition, normalization, and exchange in a retail ecosystem. In general, the present disclosure describes systems and methods for receiving, accessing, and transmitting document data transactions of trading/market participants in a retail ecosystem, as well as performing data transformations needed to efficiently connect the trading participants and exchange data therebetween.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of distributed and/or networked devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server, may comprise a network of distributed hardware and software components, or may be otherwise connected parts of a computer network. The hardware and software components may be located within a single location or, in other embodiments, portions of the hardware and software components may be divided among a plurality of locations and connected directly or through a computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted, or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the disclosure.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of or “generally free of” an ingredient or element may still actually contain such item as long as there is generally no measurable effect thereof.

As described above, the supply chain management industry serves thousands of retailers around the world, speeding the ordering, fulfillment, and disposition of goods and services from tens of thousands of suppliers. The network of participants in this industry can be defined as a retail ecosystem comprising a network of organizations, including suppliers, distributors, customers, competitors, government agencies, and others involved in the delivery of a specific product or service through both competition and cooperation. Each business in the “ecosystem” affects, and is affected by, the others, creating a constantly evolving relationship in which each business must be flexible and adaptable in order to survive, as in a biological ecosystem.

Supply chain management involves communicating data related to the exchange of goods among these trading partners in the retail ecosystem. A significant hurdle in addressing such concerns is the sheer number of connections that exist between retailers, suppliers, and other participants of the retail ecosystem. Conventionally, retailers, suppliers, and other trading partners of a retail ecosystem have relied on basic data formats with standardized syntax for communication between one trading partner and another in order to facilitate the electronic transfer of information. Data formats with standardized syntax may include, for example, but are not limited to, Electronic Data Exchange (EDI), Extensible Markup Language (XML), and flat file architectures. EDI, in a sense, may be most easily understood as the replacement of paper-based purchase orders and other POS data with electronic equivalents. The basic elements of an EDI architecture are: the use of an electronic transmission medium (e.g., the Internet or other network); the use of structured, formatted content that may comply with one or more standards or specifications (such that messages can be translated, interpreted, and checked for compliance); delivery of electronic documents from sender to receiver; and direct communication between applications (rather than merely between computers). XML, as will be recognized by those skilled in the art, is a markup language utilized to tag documents for navigation. A flat file architecture, as used herein, includes a plain text file, usually containing one record per line, a binary file, or the like. Within such a record, the single line records can be separated by delimiters such as comma (e.g., in a comma-separated values (CSV) file) or tab characters, or may each have a fixed length.

Despite the use of data formats with standardized syntax, there remains great variability, amongst trading partners, in the structure as well as the particularly selected syntax used for describing the same piece of data. For example, not all trading partners in a retail ecosystem use the same data format (e.g., EDI, XML, etc.), and, indeed, trading partners will often use different data formats. Additionally, each trading partner using a particular data format (e.g., EDI, XML, etc.) may use that data format in different ways to specify their data. That is, each trading partner, even if using the same or similar data format, may use the chosen data format in ways that differently specifies data that is otherwise similar across trading partners. Likewise, each trading partner may desire to have specific data, that it may deem important, included in their transmitted communications or communications received by them from other trading partners. However, such data may not be deemed as important to other trading partners, which may find the data excessive, omit such data from their communications, and/or otherwise specify the data in such a different way that it is difficult for trading partners to access or understand. As a result, the exchange of data or information under conventional methods has been performed in the context of a specific, one-to-one, sender/receiver relationship within a retail ecosystem, with the sender and receiver each carefully parsing through the communications received from the other in order to access the necessary or desired data.

The various embodiments of the present disclosure improve on the methods for efficiently managing the number of connections that exist between retailers and other participants of the retail ecosystem and may eliminate many of the current inefficiencies with conventional supply chain management data intake, integration, management, and exchange. The various embodiments of the present disclosure provide solutions for trading participants in a retail ecosystem for integration, collaboration, and connectivity between participants, which in turn improve the speed, accuracy, and efficiency with which goods are ordered and supplied.

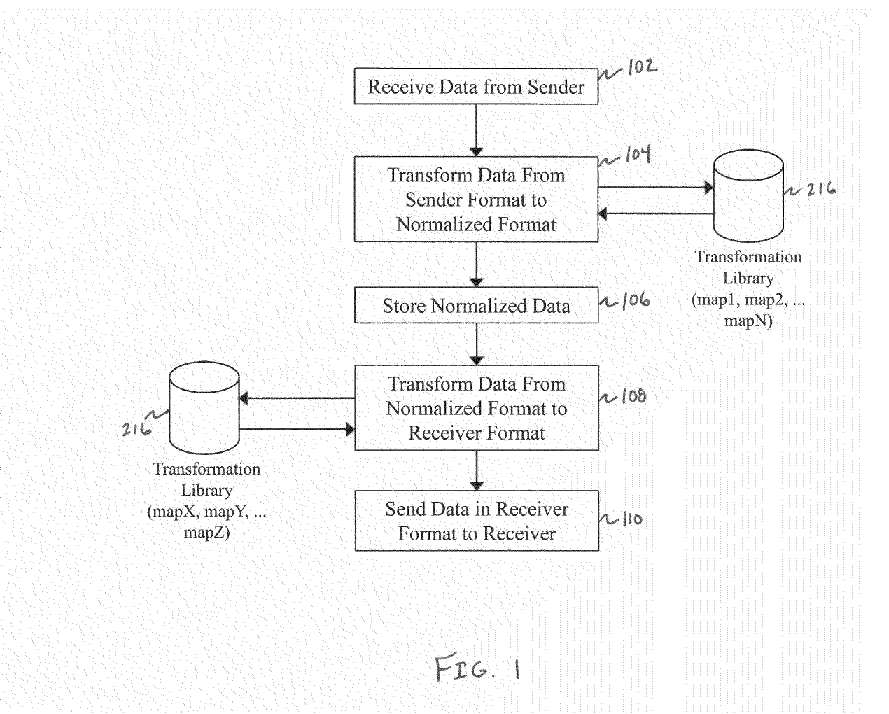

In general, the various embodiments of the present disclosure provide a novel and advantageous means for acquiring data related to the exchange of goods, which may be represented in a variety of different formats and which may have been provided by different trading partners under inconsistent standards, and normalizing the data so that it can be presented to other trading partners as participants in the system in a meaningful manner per their individual format rules, permitting the participant trading partners to make better and more expeditious business decisions. More specifically, in one embodiment, illustrated in FIG. 1, a data acquisition, normalization, and exchange system of the present disclosure, at a general level, may include one or more system components or subsystems for receiving data from a sending participant of the retail ecosystem 102, transforming the received data to a normalized or canonical foiinat 104 and storing the normalized data 106 in an electronic database or other memory location, transforming the normalized data to a format defined for a receiver of the data 108, and sending the data to the receiver 110, in the format defined for the receiver.

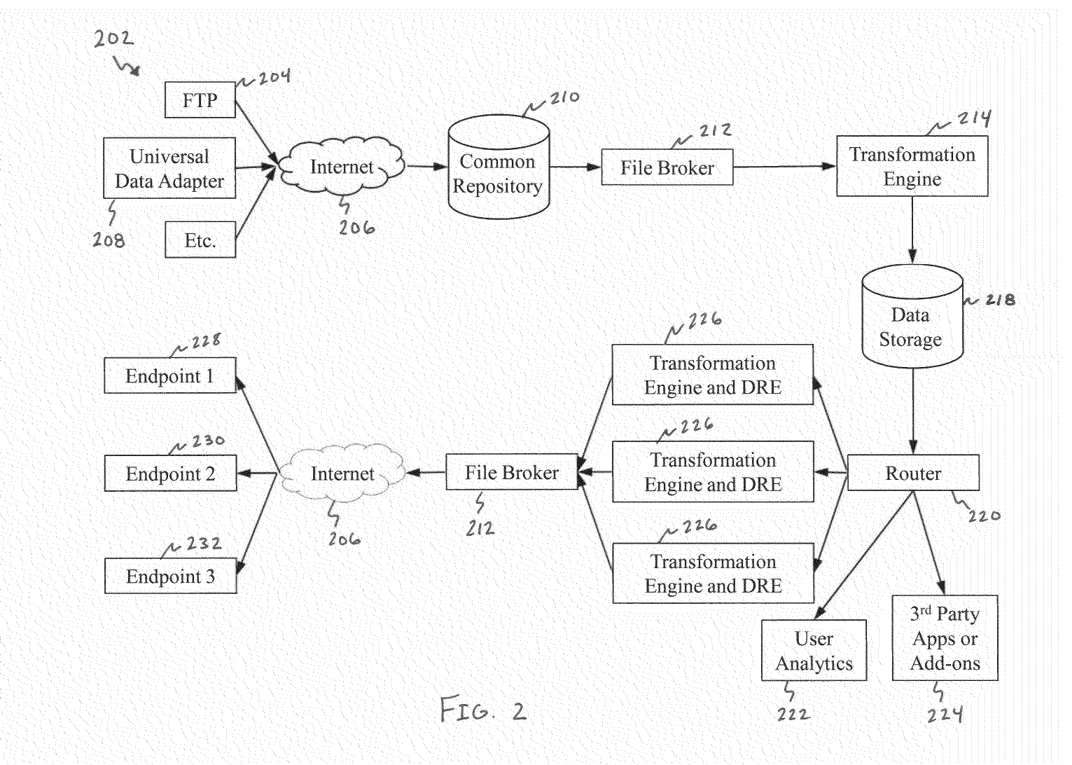

With reference to FIGS. 1 and 2, a data acquisition, normalization, and exchange system of the present disclosure may receive data or documents 102 from a trading partner or participant of a retail ecosystem through a data intake process. As described above, trading partners of a retail ecosystem may include, but are not limited to, retailers, suppliers, manufacturers, distributors, third-party logistics providers, fulfillment and warehousing providers, factoring firms, sourcing companies, customers, competitors, government agencies, and others involved in the delivery of a specific product or service. A data acquisition, normalization, and exchange system of the present disclosure may be configured to receive data or documents from a trading partner through a variety of data sources and in a variety of different formats. Typically, data may be received in the form of electronic documents comprising various amounts of data. Such electronic document formats include but are not limited to, EDI, XML, and flat file architectures, such as text files. However, data may be received in any other format, including via direct entry or a suitable streaming data portal. As particularly illustrated in FIG. 2, a data acquisition, normalization, and exchange system of the present disclosure may receive data from a trading partner via various data sources 202, such as but not limited to, FTP (File Transfer Protocol) or sFTP (SSH File Transfer Protocol) 204, AS2 (Applicability Statement 2 protocol), VAN (Value-Added Network), HTTP (Hypertext Transfer Protocol), and/or any other suitable transfer protocol or web server, each of which may be communicatively coupled with the data acquisition through a network 206, such as the Internet.

A data acquisition, normalization, and exchange system of the present disclosure may provide one or more web service application programming interfaces (APIs) to enable data intake from trading partners via these data sources 202. Using an API of the present disclosure, trading partners in the retail ecosystem may be able to perform a variety of functions enabled by a data acquisition, normalization, and exchange system of the present disclosure, such as but not limited to, send and receive data and documents, generate printer-ready shipping labels that meet a particular trading partner's specification, get detailed location information for a given retail location identifier, get and update information about items and their inventory, and access or update cross-reference information, including information about how trading partner item identifiers relate to one another. For example, an API of the present disclosure may include, but is not limited to, the following services:
Document Send Service—Provides a trading partner with the ability to send a document(s) or other data to a data acquisition, normalization, and exchange system of the present disclosure for processing. Such a service may primarily be used by trading partners to send documents to one or more other trading partners via the data acquisition, normalization, and exchange system, as will be described in further detail below.
Document Receive Service—Provides a trading partner with the ability to retrieve or receive a document(s) or other data waiting at the data acquisition, normalization, and exchange system to be delivered. Such a service may primarily be used by each trading partner to retrieve documents that have been sent to it from one or more other trading partners connected with the data acquisition, normalization, and exchange system.
Document Query Service—Provides a trading partner with the ability to query the data acquisition, normalization, and exchange system to determine, for example, the status of a document it sent or whether there are documents that have been sent to it and are ready to retrieve.

In one embodiment, a data acquisition, normalization, and exchange system of the present disclosure may provide a universal data adapter 208 configured for receiving data from a trading partner. The universal data adapter 208 may be hardware, software, or a combination of hardware and software that ties in with or connects with a trading partner's hardware and/or software system or systems, enabling the receipt of data therefrom by the data acquisition, normalization, and exchange system. In one embodiment, for example, the universal data adapter 208 may be software provided on the trading partner side that the trading partner can configure to connect to one or more of their hardware and/or software systems, such as but not limited to, their inventory and/or accounting systems. The universal data adapter 208 may be configured to poll for new data associated with the trading partner to which it is associated, such as but not limited to, new purchase orders, invoices, status updates, etc. and may send such new data from the associated trading partner's system to the data acquisition, normalization, and exchange system of the present disclosure for processing. The universal data adapter 208 may be configured to poll for new data at the associated trading partner's system(s) continuously, periodically, at random times, or according to any other suitable schedule or pattern, as may be desired. While the above description specifically identifies a variety of transfer protocols or adapters for receiving data from a trading partner, any other suitable means for receiving data may be utilized, including for example, manual data entry into the data acquisition, normalization, and exchange system, and the various embodiments of the present disclosure are not limited to only those example means for data intake explicitly disclosed.

In some embodiments, a data acquisition, normalization, and exchange system of the present disclosure may additionally include validation or quality control mechanisms, to help ensure the validity and quality of the intake data, verify receipt of the intake data, or otherwise check up on the data as it moves through the data acquisition, normalization, and exchange system. In one embodiment, for example, the data acquisition, normalization, and exchange system may implement and deploy one or more high level quality control checks on the received or retrieved data, such as but not limited to, checking whether expected data is on time or not, whether received or retrieved data is in the correct or an otherwise expected format, whether the same content has been previously received or retrieved (duplicate information), whether the size of the received or retrieved data is in a specified tolerance of what is expected, or any other suitable high level quality control measures. Likewise, in one embodiment, for example, the data acquisition, normalization, and exchange system may implement and deploy alternative or additional lower level, or higher intelligence, quality control checks on the received or retrieved data, such as but not limited to, checking that data values in the received or retrieved data files are within predetermined tolerance thresholds, that typical or required data (such as but not limited to, a store number, item record, UPC number, etc.) is in fact present in the data, that values expected to be greater than zero are in fact at least zero, or any other suitable quality control measures, such as those which may not typically be checkable at the time of data acquisition. Indeed, a data acquisition, normalization, and exchange system of the present disclosure may additionally or alternatively include validation or quality control mechanisms at any other process step described herein, such as but not limited to, during transformation or normalization of the data, which is described in further detail below.

Regardless of data intake method, in one embodiment of the present disclosure, as illustrated in FIG. 2, data received from trading partners may be deposited or stored in a common repository 210. Common repository 210 may, in one embodiment, be a singular memory location or storage device. In other embodiments, common repository 210 may be comprised of two or more memory locations and/or storage devices, of the same or of different type. The various memory locations and/or storage devices of such a common repository 210 may be provided in a single location or may be distributed over a plurality of locations and communicatively connected with other parts of a data acquisition, normalization, and exchange system of the present disclosure via a network, such as the Internet. Further yet, while referred to herein as a “common” repository, the various memory locations and/or storage devices of the common repository 210 may or may not be communicatively coupled with one another. In general, the common repository 210 comprises one or more memory locations or data storage devices that receive and hold data received via the data intake process for subsequent processing, and such memory locations or data storage devices need not, but could be, a singular data storage repository or a distributed storage system, where each memory location and/or storage device of such repository or storage system may or may not be communicatively coupled with one another. A data acquisition, normalization, and exchange system of the present disclosure may have communicative access to any part of the common repository, be it direct or networked connection.

As illustrated in FIG. 2, in one embodiment, a data acquisition, normalization, and exchange system of the present disclosure may include a file broker 212 that, in general, directs or guides data sitting at some location of the data acquisition, normalization, and exchange system to another location. The file broker 212 may intercept and/or guide data at various locations or steps throughout acquisition, normalization, and/or exchange of data through the retail ecosystem. In one embodiment, the file broker 212 may direct or guide data received from trading partners as part of the intake process and/or data sitting in the common repository 210 into the workflow of the data acquisition, normalization, and exchange system. As part of the workflow, the file broker 212 may direct or guide data received from trading partners as part of the intake process and/or data sitting in the common repository 210 to a transformation engine 214 for transforming the received data to a normalized or canonical format. However, guiding data to the transformation engine 214 may be but one example of how the file broker 212 may guide data into or through the data acquisition, normalization, and exchange system.

As described above, despite the use of electronic data formats with standardized syntax, such as EDI, XML, etc., there remains great variability, amongst trading partners, in the structure as well as the selected syntax used for describing the same piece of data, and the data acquisition, normalization, and exchange system of the present disclosure may be configured to receive data with this variability. Accordingly, one or more transformation engines 214 may be provided and configured to transform or normalize the data, to what is referred to herein as normalized data or data in a normalized format. The data may be normalized without regard to the receiver to which such data is destined and/or the particular sender/receiver communication relationship corresponding to the data.

The normalized format, in one embodiment, is a consistent structure and format defined for the retail space/industry. The consistent structure and format may be defined based on a dictionary and/or library for the retail space/industry of common communications, transactions, and forms, such as but not limited to, purchase orders (POs) and invoices, and/or the common data specifically provided in such communications and transactions, such as but not limited to, retailer/supplier IDs, product IDs, PO and invoice numbers, store locations, etc. Although such data may be formatted and defined differently by each trading partner in the retail ecosystem, the data acquisition, normalization, and exchange system can utilize one or more transformation engines 214 to normalize the data from each trading partner's format to the consistently structured and defined normalized format provided by the data acquisition, normalization, and exchange system.

Generally, a transformation engine 214 may normalize any received data, such as EDI or XML document data, by mapping received data according to map objects generated from trading partner defined specification models. Each map object may embed logic or otherwise comprise a set of data relationships associating a particular portion or piece of the data used by a particular trading partner in its communications, transactions, or forms with a corresponding element or data object in the normalized format of the data acquisition, normalization, and exchange system. In this way, each map object may generally be considered a “blueprint” or taxonomy that describes the relationship between each trading partner's data specifications and the normalized format of the data acquisition, normalization, and exchange system. A map object may further include a specification of document characteristics, such as mandatory and conditional data elements, minimum/maximum requirements for a particular data field, and field type(s), such as numeric or alphanumeric, which can, for example, assist with data validation and quality control measures of the data acquisition, normalization, and exchange system.

In one embodiment, trading partners may define their specification models through a user interface (UI) and/or programming code. A data acquisition, normalization, and exchange system of the present disclosure may therefore provide a map authoring tool having a UI, such as but not limited to, a graphical user interface (GUI), permitting a trading partner to easily define one or more specification models. The map authoring tool may permit a trading partner to define their specification models in a human readable format without requiring the knowledge or understanding of programming languages and constructs, thereby allowing generally any representative of the trading partner to define a specification model. However, the map authoring tool may include the ability for defining trading partner specification models through the alternative or additional use of programming code, such as but not limited to, Java or an Xpath-like dialect (Xpath is a language for finding information in an XML document).

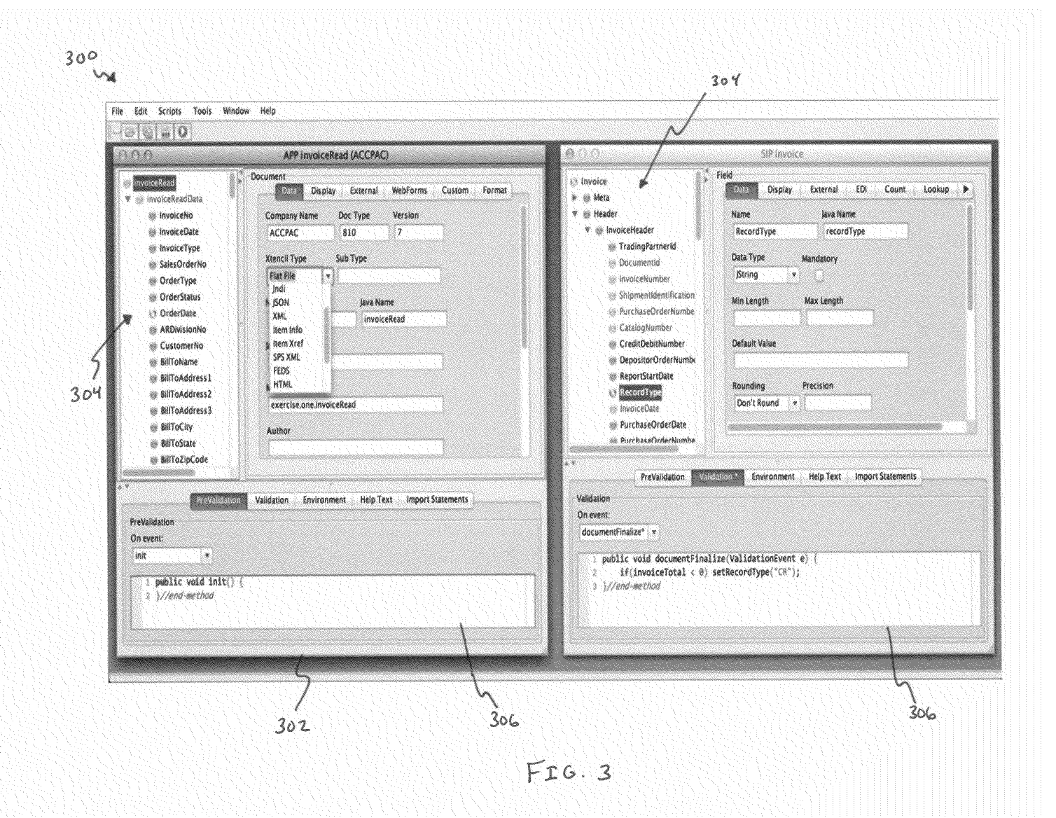

More specifically, in one embodiment, illustrated in FIG. 3, a map authoring tool 300 may include a GUI designed for trading partners to create specification models that describe relationships between each trading partner's data specifications and the normalized format of the data acquisition, normalization, and exchange system without explicitly coding the relationships into machine code. The map authoring tool or other portion of the data acquisition, normalization, and exchange system may then generate, and in some embodiments dynamically generate, a machine readable schema, referred to herein as a map object, from the trading partner defined specification model that will be usable by the transformation engine 214 to automatically normalize data received by each trading partner. The machine readable schema may be any suitable machine readable schema, including but not limited to, an XML schema. In one embodiment, the map authoring tool 300 may include a web-based GUI, accessible over the Internet.

Even more specifically, in one embodiment, the map authoring tool 300 may permit a trading partner to upload or import an electronic document file, for example in EDI, XML, CSV, or other suitable data format. The imported file may correspond to a document, such as but not limited to, a PO or invoice, utilized by the trading partner in its communications and/or transactions within the retail ecosystem. Of course, the document type is not limited to POs or invoices, but could be any suitable document used by the trading partner to communicate or cooperate with other trading partners in the retail ecosystem. The map authoring tool 300 may permit the trading partner to select the type of document (e.g., PO, invoice, etc.) uploaded, in order to correspond the document with the most appropriate set of normalized data elements or objects. In a more particular embodiment, for example, the map authoring tool, may permit a trading partner to select, from a list or through a software wizard, the specific retail industry, order management model, and corresponding document type available in the data acquisition, normalization, and exchange system to which the uploaded document most appropriately relates. The map authoring tool 300 may then present a trading partner with a GUI 302 appropriate for the uploaded document and including, based upon the trading partner's selections, a list of normalized data objects 304 likely corresponding to similar data elements of the trading partner's uploaded document. The trading partner may then use the GUI 302 to link one or more data elements of its document with one or more normalized data objects from the list of data objects 304. In one embodiment, the GUI 302 may include a variety of UI features, such as but not limited to, drag-and-drop capability, drop-down lists, radio buttons, text boxes, etc., permitting easy selection and linkage of data objects from the trading partner's document with normalized data objects from the list of data objects 304, as well as defining any other data constraints or characteristics. In this regard, the trading partner may easily interact with well-established and understood graphical widgets to link data objects. In general, the map authoring tool 300 and GUI 302 may permit a trading partner to interact with the data acquisition, normalization, and exchange system in an easy and efficient manner to view and/or define, per document or transaction type, the relationship between data objects from the trading partner's documents with normalized data objects. Linked data elements or objects ultimately define how the transformation engine 214 will transform data from the trading partner's style and format to the normalized format of the data acquisition, normalization, and exchange system, as well as conversely define how the transformation engine 214 will transform normalized data to the trading partner's style and format.

In one embodiment, as indicated above, the map authoring tool 300 may also include a trading partner accessible programming code editing pane 306, permitting a trading partner to “hard code” a data relationship or other data constraints or characteristics. Such a code editing pane 306 may permit a trading partner to embed, for example, event-driven logic into any data element or constraint, allowing additional flexibility in the mapping process. Event-driven logic may be described by the trading partner in, for example, Java or any other suitable programming language.

In addition to defining relationships between trading partner data and the normalized data format, the map authoring tool 300 may further permit a trading partner to define other data or document characteristics or constraints, such as but not limited to, constant values, default values, mandatory and conditional data elements, minimum/maximum requirements for a particular data field, and field type(s), such as numeric or alphanumeric, just to name a few examples. In general, the map authoring tool 300 may permit a trading partner to provide any suitable specification, required or desired, for the data or documents it uploads to the data acquisition, normalization, and exchange system, such that the system can create, and in some embodiments dynamically create, a map object permitting automatic transformation of the trading partner data to the normalized format.

The map authoring tool 300 may also be configured for selection, viewing, and/or revision, by a trading partner, of existing map objects. The map authoring tool 300 permits the existing map objects to be viewed and/or revised in a human readable format.

As indicated above, the map authoring tool 300 or other suitable portion of the data acquisition, normalization, and exchange system may generate, and in some embodiments dynamically generate, a machine readable schema, or map object, for each document type used by a trading partner based on the trading partner's defined specification models for its documents. The map objects may be usable by the transformation engine 214, for each document type, to both automatically normalize document data received from the corresponding trading partner and, conversely, automatically transform normalized data to the corresponding trading partner's desired or preferred format.

With reference back to FIG. 1, the map objects may be stored in a transformation library or database 216, accessible by the one or more transformation engines 214. Like the common repository 210, the transformation library 216 may comprise one or more memory locations or data storage devices that receive and hold the generated map objects, and such memory locations or data storage devices need not, but could be, a singular data storage repository or a distributed storage system, where each memory location and/or storage device of such repository or storage system may or may not be communicatively coupled with one another.

In one embodiment, a transformation engine 214 may be an application that executes the mapping transformation or transformation instructions contained within the map objects of the transformation library 216. As indicated above, in some embodiments, a transformation engine 214 may additionally perform validation or quality control, at a high and/or low intelligence level, on the data as it is normalized, to help ensure the validity and quality of the intake data, verify receipt of the intake data, or otherwise check to make sure the data is validly within any defined constraints. For example only, a transformation engine 214 may check whether expected data is on time or not, whether received or retrieved data is in the correct or an otherwise expected format, whether the same content has been previously received or retrieved (duplicate information), whether the size of the received or retrieved data is in a specified tolerance of what is expected, whether data values in the received or retrieved data files are within predetermined tolerance thresholds, whether typical or required data (such as but not limited to, a store number, item record, UPC number, etc.) is in fact present in the data, whether values expected to be greater than zero are in fact at least zero, whether default values are set, whether replacement values or supplemental data is required, or any other suitable high or low level quality control measures. Where it is able and it is appropriate, the transformation engine 214 may automatically correct any identified validation or quality control issues, for example, based on the definition in the corresponding map object, and/or the transform engine 214 may alert the trading partner to the identified control issues for correction.

With reference back to FIG. 2, a data acquisition, normalization, and exchange system of the present disclosure may store normalized document data for a received trading partner document in a normalized data storage repository 218, accessible by the one or more transformation engines 214. Like the common repository 210 and transformation library 216, the normalized data storage repository 218 may comprise one or more memory locations or data storage devices that receive and hold the normalized data, and such memory locations or data storage devices need not, but could be, a singular data storage repository or a distributed storage system, where each memory location and/or storage device of such repository or storage system may or may not be communicatively coupled with one another.

A data acquisition, normalization, and exchange system of the present disclosure may also include a router 220, communicatively coupled with the normalized data storage repository 218, for accessing the normalized document data and routing the data through the data acquisition, normalization, and exchange system toward the appropriate endpoint, such as a designated receiving trading partner. In some embodiments, the router 220 may additionally or alternatively route normalized data to one or more trading partner analytics components 222 and/or applications components 224. The trading partner analytics components 222 may be part of the data acquisition, normalization, and exchange system and/or may be provided by one or more third-party entities. In general, a trading partner analytics component 222 may receive the normalized data and format the data in one or more various ways for a trading partner or other user to review and analyze in an efficient and consistent manner, thereby providing the trading partner with improved business intelligence. More details relating to a trading partner analytics component or system, usable with the presently disclosed embodiments of a data acquisition, normalization, and exchange system, are described in U.S. Prov. Pat. Appl. No. 61/793,022, titled “System and Method for Data Acquisition, Data Warehousing, and Providing Business Intelligence in a Retail Ecosystem,” filed Mar. 15, 2013, the contents of which are hereby incorporated by reference herein in their entirety. Applications components 224 may include third-party entity applications, apps, or system add-ons, that may be configured to perform any suitable operation or analysis on the normalized data and present the data to a trading partner or user in a meaningful way. The third-party entity applications, apps, or system add-ons are not limited in their capability by the present disclosure.

The router 220 may, in one embodiment, route normalized document data toward a trading partner designated as the receiver for the data. As an initial step toward getting the data to the appropriate endpoint or trading partner receiver, the router 220 may route the normalized document data through a transformation engine 226, for transformation from the normalized format to a format for the trading partner receiver. Transformation engine 226 operates similar to, and in some embodiments, may be, the same as, transformation engine 214. In this regard, transformation engine 226 may generally transform or de-normalize document data stored in the normalized data storage repository 218 by mapping the normalized data according to the map objects described above, generated from trading partner defined specification models and stored in transformation library 216. As indicated above, each map object may embed logic or otherwise comprise a set of data relationships associating a particular portion or piece of the data used by a particular trading partner in its communications, transactions, or forms with a corresponding element or data object in the normalized format of the data acquisition, normalization, and exchange system. As indicated above, not only may such map objects be used to transform received data to the normalized format, but the map objects may also conversely be used to transform data out of the normalized format and into a format preferred or desired by any given trading partner, as defined by that trading partner. The format from one trading partner may, and often will, differ from that of other trading partners. The data may be de-normalized without regard to the sender from which such data was received and/or the particular sender/receiver relationship. Generally, normalization may normalize received data from a first, sending trading partner using a map object generated based on the first trading partner's specification model for the document data, and de-normalization may transform normalized data to a format configured for a second, receiving trading partner using a different map object generated based on the second trading partner's specification model for the document data. Accordingly, in one embodiment, it is not a direct mapping from a first, sending trading partner's format to a second, receiving trading partner's format, but a mapping from a first, sending trading partner's format to a normalized format, where the specific sender/receiver relationship is generally irrelevant, and then a mapping from the normalized format to a second, receiving trading partner's format. In this regard, there may be an isolation of the sending and receiving transformations from one another.

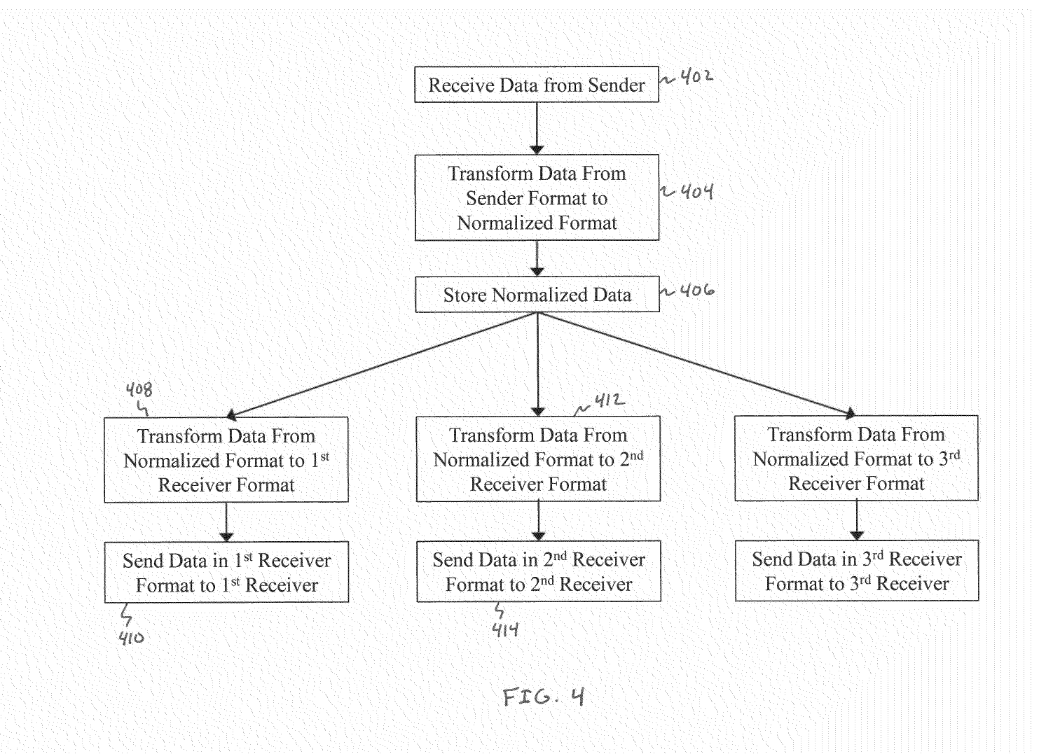

As a result, in some embodiments, illustrated particularly in FIG. 4 but also illustrated in FIG. 2, a data acquisition, normalization, and exchange system of the present disclosure, at a general level, may include one or more system components or subsystems for receiving data from a sending participant of the retail ecosystem 402, transforming the received data to a normalized or canonical format 404, and storing the normalized data 406 in an electronic database or other memory location. From the normalized format, a data acquisition, normalization, and exchange system of the present disclosure may further include one or more system components or subsystems for transforming the normalized data to a separately defined format for each and every one of any suitable number of designated trading partner receivers of the data, and sending the data to each receiver, in the corresponding format defined for that receiver. More specifically, a data acquisition, normalization, and exchange system of the present disclosure may transform 408 the normalized data to a format defined for a first designated trading partner receiver, based on a map object generated from a specification model created, for example, using the map authoring tool 300, by the first designated trading partner receiver. The data acquisition, normalization, and exchange system of the present disclosure may then send the de-normalized data to the first designated trading partner receiver 410, in the first designated trading partner receiver's corresponding format. Likewise, the data acquisition, normalization, and exchange system of the present disclosure may transform 412 the same normalized data to another format defined for a second designated trading partner receiver, based on a map object generated from a specification model created, for example, using the map authoring tool 300, by the second designated trading partner receiver. The data acquisition, normalization, and exchange system of the present disclosure may then send the de-normalized data to the second designated trading partner receiver 414, in the second designated trading partner receiver's corresponding format. A similar process may be repeated for any number, n, of designated trading partner receivers, each receiving data transformed from the normalized format to a format defined by a map object generated from a specification model created by the corresponding designated trading partner receiver.

In further embodiments, as part of transformation engine 226 or as an additional component of a data acquisition, normalization, and exchange system of the present disclosure, a document rules engine (DRE) may be provided that, in addition to transformation of the normalized data, may dictate or direct if and how certain data should be modified. The DRE may modify the data based on relationship specific rules, allowing trading partners to define variations in the way a trading partner sends data to, and receives data from, different specified trading partners in the retail ecosystem via the data acquisition, normalization, and exchange system. For example, relationship specific rules may include, but are not limited to, those based on the underlying data itself, based on who the sender and/or receiver of the data is, based on a particular sender/receiver relationship, or any other suitable criteria defined by the sending and/or receiving trading partner in a specified sender/receiver relationship. In general, besides simply defining linked data element relationships and other data characteristics, as described above, a trading partner may additionally define transformation or map preferences that define how the trading partner desires the transformation to be customized or “tweaked,” for example, based on the specific relationship between the sending and receiving trading partners. Rules for the DRE may be defined by trading partners using any suitable methods, such as but not limited to, using the map authoring tool 300 or similar UI, or through the use of programming code, such as but not limited to, Java or an Xpath-like dialect.

As indicated above, upon transformation or de-normalization to the format specified for a particular trading partner receiver, a data acquisition, normalization, and exchange system of the present disclosure may send the data in the corresponding format to the corresponding trading partner receiver. In one embodiment, file broker 212 may again be utilized to direct or guide the data to the appropriate endpoint location 228, 230, 232. Specifically, the file broker 212 may intercept and/or guide data from the transformation engines 226 to the correct trading partner receiver. As with guiding data to a transformation engine 214, guiding data from a transformation engine 226 to the appropriate endpoint 228, 230, 232 may be but one example of how the file broker 212 may guide data through or out of the data acquisition, normalization, and exchange system.

Similar to the data intake process, a data acquisition, normalization, and exchange system of the present disclosure may send data to a trading partner via various transfer protocols, such as but not limited to, FTP or sFTP, AS2, VAN, HTTP, and/or any other suitable transfer protocol or web server, each of which may be communicatively coupled with the data acquisition through a network 206, such as the Internet. In additional or alternative embodiments, a data acquisition, normalization, and exchange system of the present disclosure may send data to a trading partner via the universal data adapter 208, described in detail above.

In some embodiments, a data acquisition, normalization, and exchange system of the present disclosure may include automatic data cross-referencing. For example, in one embodiment, as data passes through the data acquisition, normalization, and exchange system, the system may automatically pull data about a particular trading partner, such as a retailer, and update databases corresponding to that trading partner. More specifically, for example, as data about a retailer's warehousing locations is sent through the data acquisition, normalization, and exchange system, it may automatically update data corresponding to that retailer's warehouse locations, in order to keep such information up to date. Additionally, for example, where various trading partners utilize different product/part numbers for identifying the same part, the data acquisition, normalization, and exchange system can automatically store cross-referencing information about the product/part numbers for the various trading partners and utilize the stored information to modify normalized data for a particular trading partner with the appropriate cross-references. Additionally, such cross-referencing information may be updated automatically based on data received from the trading partners, for example, through provided electronic spreadsheets or other electronic documents, or by an electronic communication channel connected with the trading partners' system(s). The foregoing examples, of course, are only some examples, and this type of supplementing has broad application to the data and is not limited to solely those examples provided. Indeed, in some embodiments, trading partners may even define custom fields, specifically configured for receiving a particular piece of cross-referenced data. In general, however, cross-referencing permits the data acquisition, normalization, and exchange system to supplement or modify any data provided by a trading partner with additional information or value based on cross-referencing information the system gleans from data passing therethrough or other information supplied by trading partners.

Similarly, trading partners may define, for the data acquisition, normalization, and exchange system, how to find correlating documents in the system based on information in an uploaded document. For example only, a trading partner may define, for the data acquisition, normalization, and exchange system, how to find a corresponding PO from information contained in an uploaded invoice, such as a PO number. However, this type of correlating is not limited to just POs and invoices, and certainly there are other correlating documents for which this feature may be useful. In general, trading partners may define, for the data acquisition, normalization, and exchange system, how to find correlating documents by identifying particular fields or other data in an uploaded document that may be used to find other correlating documents. In one embodiment, trading partners may identify such fields or data via their specification models created using the map authoring tool 300. However, another similar UI may alternatively be provided.

The various embodiments of a data acquisition, normalization, and exchange system of the present disclosure have numerous advantages. For example, the various embodiments of the system permit each trading partner to customize their own format without regard to who they are sending data to or receiving data from, while permitting the system to take advantage of a structured normalized environment for consistent processing. The various embodiments of the present disclosure enable a self-provisioning process where a trading partner in the retail ecosystem has the ability to view a directory of trading partners and their corresponding products, capabilities, and certifications and can initiate a relationship with other trading partners quickly and efficiently, whereby the embodiments of the present disclosure become responsible for the consistent exchange of data between the trading partners, so that the trading partners can begin exchanging information electronically with reduced or minimal manual effort and reduced risk. Trading partners who have been accepted and linked with a data acquisition, normalization, and exchange system of the present disclosure and have created their specification models may add trading partner connections and trade with any other (accepting) trading partner in the connected retail ecosystem without additional development at their end or additional configuration with the system of the present disclosure. Other advantages of the various embodiments of the present disclosure will be recognized by those skilled in the art.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for normalizing and exchanging document data relating to an exchange of goods between trading partners in a retail ecosystem, the method comprising:
acquiring electronic document data from a first trading partner through an electronic network, the electronic document data provided in a first format and relating to a document type utilized by the first trading partner in exchanging goods between one or more other trading partners in the retail ecosystem;
transforming the electronic document data to a normalized format based on a dynamic map object for the document type generated based on a first specification model defined by the first trading partner, the first specification model defining relationships between data specifications of the first trading partner for the document type and data specifications for the normalized format for the document type;
storing the transformed electronic document data in the normalized format in a normalized data storage repository comprised of one or more computer readable storage devices;
de-normalizing the transformed electronic document data from the normalized format to a second format based on a dynamic map object for the document type generated based on a second specification model defined by a second trading partner, the second specification model defining relationships between data specifications of the second trading partner for the document type and data specifications for the normalized format for the document type; and
transmitting the de-normalized electronic document data in the second format to the second trading partner through the electronic network.

2. The method of claim 1, wherein acquiring electronic document data from a first trading partner through an electronic network comprises acquiring electronic document data through a universal adapter module, permitting polling of one or more of the first trading partner's systems for new document data and acquiring the new document data.

3. The method of claim 1, further comprising storing the electronic document data provided in a first format in a storage repository comprised of one or more computer readable storage devices.

4. The method of claim 1, wherein transformation of the electronic document data to a normalized format is independent of where the electronic document data is destined.

5. The method of claim 1, wherein the first specification model defined by the first trading partner further defines one or more data constraints for data within the electronic document data.

6. The method of claim 5, wherein transforming the electronic document data to a normalized format comprises validating data within the electronic document data based on the one or more data constraints defined by the first trading partner.

7. The method of claim 1, further comprising:
de-normalizing the transformed electronic document data from the normalized format to a third format based on a dynamic map object for the document type generated based on a third specification model defined by a third trading partner, the third specification model defining relationships between data specifications of the third trading partner for the document type and data specifications for the normalized format for the document type; and
transmitting the de-normalized electronic document data in the third format to the third trading partner through the electronic network.

8. The method of claim 1, wherein de-normalizing the transformed electronic document data from the normalized format to a second format further comprises modifying the electronic document data based on specifications defined by the second trading party relating to at least one of an identification of the first trading party and an identification of a relationship between the first and second trading partners.

9. The method of claim 1, wherein de-normalizing the transformed electronic document data from the normalized format further comprises modifying the electronic document data based on data cross-referenced from data sources other than the electronic document data.

10. The method of claim 1, further comprising correlating the electronic document data acquired from the first trading partner with other document data acquired by another trading partner based on data within the electronic document data from the first trading partner.

11. A system for normalizing and exchanging document data relating to an exchange of goods between trading partners in a retail ecosystem, the system comprising:
a data intake module, operably connected with an electronic network, acquiring electronic document data from a first trading partner through the electronic network, the electronic document data provided in a first format and relating to a document type utilized by the first trading partner in exchanging goods between one or more other trading partners in the retail ecosystem;
one or more transformation engines receiving the electronic document data from the intake module and transforming the electronic document data to a normalized format based on a dynamic map object for the document type generated based on a first specification model defined by the first trading partner, and de-normalizing the transformed electronic document data from the normalized format to a second format based on a dynamic map object for the document type generated based on a second specification model defined by a second trading partner;
a normalized data storage repository, comprised of one or more computer readable storage devices, storing the transformed electronic document data in the normalized format; and
a data export module, operably connected with the electronic network, transmitting the de-normalized electronic document data in the second format to the second trading partner through the electronic network;
wherein the first specification model defines relationships between data specifications of the first trading partner for the document type and data specifications for the normalized format for the document type; and
wherein the second specification model defines relationships between data specifications of the second trading partner for the document type and data specifications for the normalized format for the document type.

12. The system of claim 11, further comprising an Internet-based user interface, accessible over an electronic network, through which each trading partner of the retail ecosystem may define one or more specification models for one or more corresponding document types.

13. The system of claim 12, wherein the Internet-based user interface comprises a graphical user interface through which each trading partner of the retail ecosystem may define its one or more specification models using graphical interface widgets, without requiring an underlying understanding of computer programming code.

14. The system of claim 13, wherein the Internet-based user interface further comprises a trading partner accessible programming code editing pane, permitting a trading partner to utilize computer programming code to define at least a portion of its one or more specification models.

15. The system of claim 13, further comprising a transformation library, comprised of one or more computer readable storage devices, storing the dynamic map objects.

16. The system of claim 13, further comprising a document rules engine modifying the electronic document data based on specifications defined by the second trading party relating to at least one of an identification of the first trading party and an identification of a relationship between the first and second trading partners.

17. The system of claim 13, wherein the one or more transformation engines further de-normalize the transformed electronic document data from the normalized format to a third format based on a dynamic map object for the document type generated based on a third specification model defined by a third trading partner, wherein the third specification model defines relationships between data specifications of the third trading partner for the document type and data specifications for the normalized format for the document type.

18. The system of claim 17, wherein the data export module further transmits the de-normalized electronic document data in the third format to the third trading partner through the electronic network

19. A method for normalizing and exchanging document data relating to an exchange of goods between trading partners in a retail ecosystem, the method comprising:
acquiring electronic documents from a plurality of sending trading partners through an electronic network, each electronic document from the sending trading partners provided in a format corresponding to which trading partner the electronic document came from, and each electronic document having a document type;
transforming the electronic documents to a normalized format based on dynamic map objects, each relating to a corresponding document type, the map objects generated based on specification models defined by the trading partners, the specification models defining relationships between data specifications of the trading partners for the document types and data specifications for the normalized format for the document types;
storing the transformed electronic documents in the normalized format in a normalized data storage repository comprised of one or more computer readable storage devices;
de-normalizing each transformed electronic document from the normalized format to one or more output formats based on the dynamic map objects for the corresponding document type; and
transmitting the de-normalized electronic documents in the one or more output formats to receiving trading partners through the electronic network.

20. The method of claim 19, wherein transformations occurring during the transforming of electronic documents to a normalized format are isolated from the transformations occurring during the de-normalizing of transformed electronic documents from the normalized format.
